(19) United States
(12) Patent Application Publication
(10) Pub. No.: US 2016/0063783 A1
(43) Pub. Date: Mar. 3, 2016

(54) Proximity Security System and Method for Industrial Door Openers

(71) Applicants: Rik Bruns, Belvidere, IL (US); Ron Seyk, Algonquin, IL (US)

(72) Inventors: Rik Bruns, Belvidere, IL (US); Ron Seyk, Algonquin, IL (US)

(21) Appl. No.: 14/632,112

(22) Filed: Feb. 26, 2015

Related U.S. Application Data
(63) Continuation of application No. 14/476,496, filed on Sep. 3, 2014.

(51) Int. Cl. G07C 9/00

(52) U.S. Cl. CPC G07C 9/00111

(57) ABSTRACT

A system and method for controlling industrial doors using smart devices that must be within a predetermined distance from the door to operate the door. A beacon such as a BLE device is placed near the door. A smart device also contains a BLE capable or other similar module. The smart device communicates with the door controller using conventional wireless technologies, either directly or through a central computer. The smart device is able to determine its distance from the door controller using the two paired devices. If the smart device is within a predetermined distance from the door, and if all other criteria for allowing access are met, the controller operates the door.

This is a continuation of application Ser. No. 14/476,496 filed Sep. 3, 2014. Application Ser. No. 14/476,496 is hereby incorporated by reference in its entirety.

### BACKGROUND

1. Field of the Invention

The present invention relates generally to smart devices controlling industrial processes, and more particularly to a system and method for controlling industrial doors only when a smart device is in proximity to the door.

2. Description of the Prior Art

There are numerous prior art systems using smart applications (Apps.) for opening and closing doors such as garage doors and other doors, mostly aimed at the residential and consumer markets. These systems allow a connected door to be operated from anywhere there is an internet connection.

In an industrial manufacturing and distribution scenario, there are many powered doors within a facility or complex. Because there is constant movement of personnel and materials, it would be unsafe to be able to operate a door from a smart device with just an internet or network connection. Both security and safety are at risk if the door can be operated from anywhere instead of within sight of the operator with a proper security clearance. What is needed is a system that can use a smart device to control industrial doors that combines two modes of wireless communication to determine, first that the operator is within a specific distance from the door, and the second to actually send the operative command in conjunction with network authorization. The system should be set up to include doors that are a part of that operator's system, and only those doors within a predetermined distance from the operator would display and be available on the smart device.

Most of these industrial doors are controlled with controllers coupled to motors. These controllers may have push-button control, and/or they may be controlled wirelessly. It is known in the art to connect these controllers together, or to a central location, via a network. We explained in our co-pending patent application Ser. No. 13/890,962 how a program executing on a PC, laptop, tablet, smartphone can communicate with any or all of the controllers in a complex, integrate control of multiple doors, perform statistical analysis on various doors, and perform other functions, and how controllers can wirelessly communicate with other controllers.

Short-range communication under a technology called BLUETOOTH is also well-known in the art. With the release of the BLUETOOTH 4.0 specification, a new sub-set of the specification was added called Bluetooth Low Energy (BLE). This sub-set enables low power, short-range and session-less wireless communication. Recently, integrated circuits have become available that use the signal strength of the BLUETOOTH signal (or signal to noise ratio) to determine the physical distance of separation between devices. This new development is typically known under the name of BEACON. Beacons can be placed in spaces so as to broadcast a signal that smart devices can use to estimate their location in the space and permit the smart device to exchange data with the beacon. A beacon is a proximity sensing profile of BLE. Beacons use a 2.4 GHz signal that can be detected up to around 200 feet away from the beacon.

It would be extremely advantageous to have a system and method for controlling an industrial door from a smart device with the added security feature of only allowing the action if the smart device is within a predetermined distance from the door (or the door controller). This distance could be chosen on a door-by-door basis.

### SUMMARY OF THE INVENTION

The present invention relates to a system and method for controlling industrial doors using smart devices that are required to be within a predetermined distance from the door to operate the door. A first embodiment places a BLE beacon device near the door and couples it to the door controller and the door controller software. Smart devices also contain BLE or other similar technology. The smart device communicates with the door controller using conventional wireless technologies such as WiFi. The smart device is able to determine the distance from the door controller using the two BLE beacon devices. If the smart device is within a predetermined distance from the door, and if all other criteria for allowing access are met, the controller operates the door. A second embodiment uses the same arrangements of BLE beacon devices, but the smart device communicates over a network with a central computer. The central computer also communicates over the network with the door controller. If the smart device reports that a door controller is within range, the central computer checks to make sure all other criteria are met, and if so, the central computer operates the door by sending a command to it over the network.

The present invention typically requires a custom module to be hard-wired to each existing door control system; however, it could be integrated into a single door controller. This door opening package can be designed to be added to any existing door control system with or without our other products.

### DESCRIPTION OF THE FIGURES

Attention is now directed at several drawings that illustrate features of the present invention.

FIG. 1 shows a block diagram of a first embodiment of the present invention.

FIG. 2 is a flow chart showing operation of the first embodiment

FIG. 3 shows a block diagram of a second embodiment of the present invention.

FIG. 4 is a flow chart showing operation of the second embodiment.

FIG. 5 is a block diagram of a third embodiment of the present invention using a wide-area network.

Several drawings and illustrations have been presented to aid in understanding the present invention. The scope of the present invention is not limited to what is shown in the figures.

### DESCRIPTION OF THE PREFERRED EMBODIMENTS

The present invention relates to a system and method for allowing a smart device to operate an industrial door only when it is within a predetermined distance from the door. Beacon devices are mounted near doors to be controlled. Most smart devices currently being sold contain the BLE sub-set of the BLUETOOTH™ 4.0 specification. This enables the smart device to utilize the proximity sensing profile of BLE to detect BLE beacons in the vicinity. An application (App.) on the smart device allows control of various doors in a facility. Several menus or control screens can be presented to the user to control the doors. When the user indicates to the App. that control of a particular door is desired, the smart device first interrogates the desired door to determine the distance. If the distance between the smart device and the door controller is less than a pre-determined threshold, the control request is sent to either the door controller or to a central computer wirelessly (or through a wireless network). A typical wireless network is called WiFi. The door controller or the central computer then responds to the request and activates the door, either opening it or closing it depending upon the nature of the request. If the distance is too great, the request is denied. While the preferred technique is to use BLE beacon devices, any short-range communication technique that can determine separation distance is within the scope of the present invention. Also, while WiFi and X-Net are used as examples, any wireless communication techniques may be used.

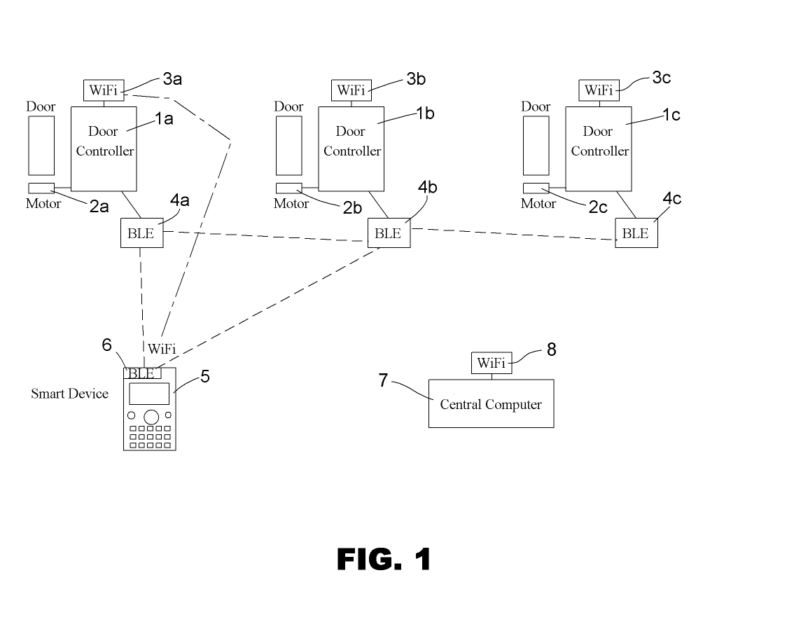

FIG. 1 shows a block diagram of a first embodiment of the present invention. A facility may contain several door controllers 1a, 1b, 1c . . . , 2a, 2b, 2c . . . . Each door controller can be equipped with a short-range communication device 4a, 4b, 4c . . . such as a BLE beacon. These BLE beacons 6 broadcast a signal that can be detected by a nearby smart device 5. Each door controller is also equipped with access to a LAN such as WiFi (3a, 3b, 3c . . . 8).

The smart device 5 can be a smartphone, a tablet computer, a PC or any other computing device that can electrically interface with a short-range communication device such as BLE 6. The smart device typically contains one or more processors, memory, GPS, stored programs or Apps., one or more display screens, a real or virtual keyboard or keypad, a microphone, speaker, short-range communication module, LAN communication capability such as WiFi, and many-times cellular telephone or other telephonic capability. The most common smart device that might be used to control doors is a smartphone running a door-control App. The smart device also has an operating system such as those operating systems sold by Apple, Microsoft, LG and Samsung and others. The leading smart devices are the iPhone™ by Apple, and devices using the Android Operating System. Each of these operating systems has an Application Interface (API) that allows users to write or download application software (Apps.).

A typical door controller (such as 1a) contains a processor with memory. A wireless Local Area Network (LAN) communication module such as WiFi and a short-range communication module such as BLE can be included internally or coupled with additional circuity and added externally to the door controller. The door controller 1a is electrically connected to a door motor 2a. The door opens and closes under control of the processor in the door controller. The door controllers throughout a facility can be connected via a wireless or wired network to one or more central computers 7. The central computer can maintain statistics as well as perform direct control of doors in some cases. The central computer 7 can also have access 8 to one or more LANs.

When a smart device 5 approaches a door controller in FIG. 11a, the two can be linked together. After linking (or pairing using the BLUETOOTH technology), the smart device can determine the distance between it (such as 4a) and the door controller 5.

In the embodiment of FIG. 1, when a user wishes to open or close a particular door (say the door controlled by motor 2a), the user accesses the door-control App. on his or her smart device (smartphone for example) and selects a previously linked door and the desired door command. The smart device determines the distance between it and the door controller. 6. The distance can be reported in feet, meters or any other convenient unit of measure. The smart device's memory contains a stored maximum distance parameter. The smart device will not be allowed to control the door beyond this distance. The smart device compares the determined distance between it and the door controller with the stored maximum distance. If the determined distance is less (or equal to) the maximum allowed distance, a message is sent over WiFi to the door controller that contains an identification signature identifying the smart device. The door controller responds to the door command by either opening or closing the door (or performing some other requested door service). If the determined distance exceeds the stored maximum distance or the identification is invalid, the request is denied. An optional message may be returned to the smart device 5 using WiFi 3a or other technique notifying the user that the distance is too great. This also happens if, for some reason, the door controller is not paired with the smart device 5.

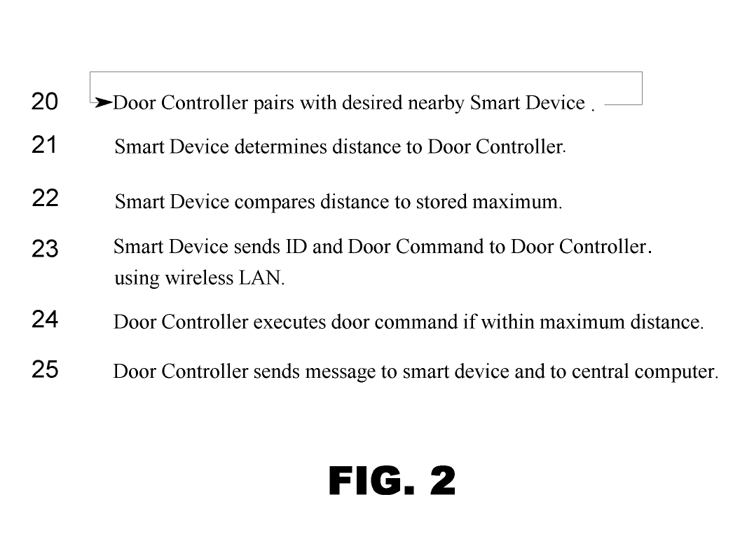

FIG. 2 shows a flow chart of the process of the embodiment of FIG. 1. In the first step 20, the door controller is linked or paired with any desired smart device within radio range. This step repeats continuously as smart devices move in and out of radio range. In the second step 21, the smart device determines the distance between it and the identified door controller. In the third step 22, the smart device compares the determined distance with a stored maximum distance parameter. In the fourth step 23, the smart device sends a door command to the particular door controller using the wireless LAN. An identification signature is also sent to verify the identity of the smart device. In the fifth step 24, the door controller executes the requested door command if the identity of the smart device is verified. In an optional sixth step 25, a message is returned over the LAN to the smart device reporting the action taken (request executed or denied).

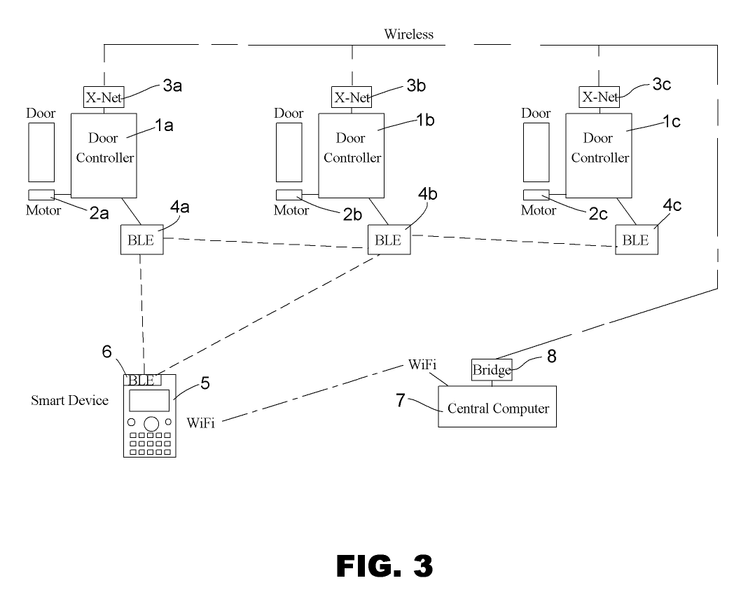

FIG. 3 shows a block diagram of a second embodiment of the present invention. The embodiment in FIG. 3 is similar to that of FIG. 1 except that the smart device 5 does not communicate directly with the door controller. Rather the smart device 5 communicates over a LAN such as X-Net with a central computer generally through a bridge 8. The central computer communicates with the smart device to determine if it is close enough to the door for the request to be executed. If it is, the central computer sends the door control command via the LAN directly to the door controller. The central computer may also send a message back to the smart device reporting the status of the request. In this embodiment, the central computer can check other parameters in addition to merely whether the smart device is close enough to the door. For example, it can query a database to see if the requester has authority to operate the particular door. For highly sensitive doors, the central computer can request the smart device to verify the identity of the user using a fingerprint or other biometric, or by requiring a pass-code (either a general password, or a code specific to that door). It should be noted that this security technique may also be used in the first embodiment (FIG. 1); however in that case, all of the security information must be contained in the smart device and/or the door controller. In the embodiment of FIG. 3, the security information may be stored in a central database.

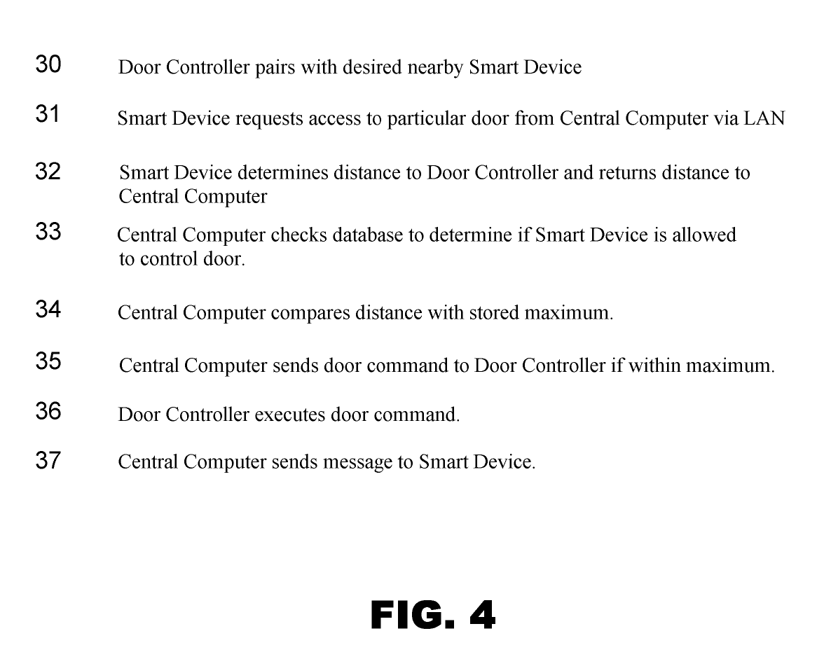

FIG. 4 shows a flow chart of the process of the second embodiment. In the first step 30, the door controller is linked or paired with any desired smart device within radio range. This step repeats continuously as smart devices move in and out of radio range. In the second step 31, the smart device requests via an IP LAN such as by WiFi to the central computer access to a particular door (for example a request to open the door). In this step, the smart device sends an identification signature to the central computer. In the third step 32, the smart device determines the distance and returns that value to the central computer via the private LAN. In the fourth step 33, the central computer checks its database to determine if that smart device is allowed to access the particular door. In the fifth step 34, the central computer checks its database for a maximum distance (either for that door or for any door) and determines if access will be allowed. In the sixth step 35, assuming access is allowed, the central computer sends a command to the door controller via the private LAN to perform the requested action. In the seventh step 36, the door controller executes the door command. In an optional eighth step 37, the central computer sends a message back to the smart device via the IP LAN reporting the results of the request.

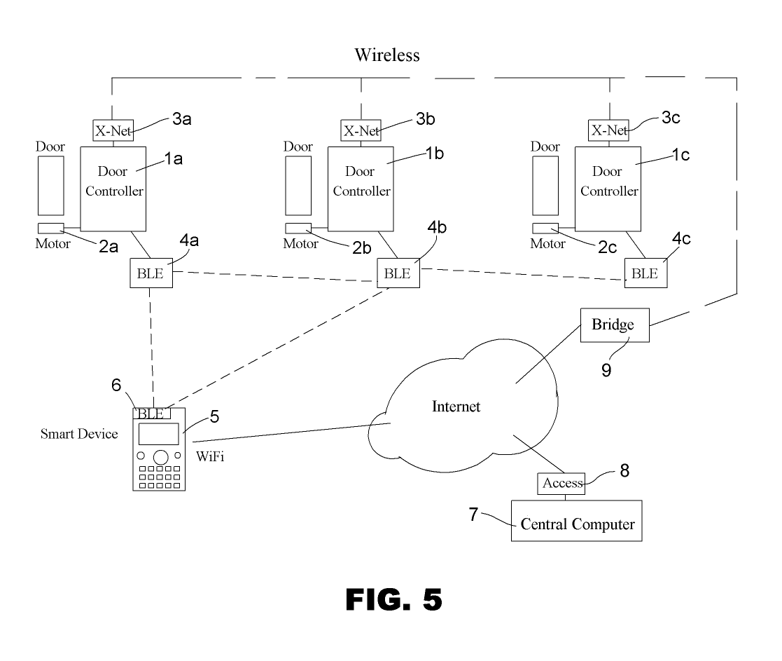

FIG. 5 shows a third embodiment where the central computer and/or database may be remote from the facility, and messages between a facility hub or bridge 9 are sent over a wide-area network such as the Internet 10 to the central computer 7 or database. In this case, extra security measures known in the art such as tunneling and/or encryption may be necessary to provide security. It is also possible for each door controller to communicate with a central computer over a wide-area network. In all cases however, according to the present invention, the requesting smart device must be within a required minimum distance for the particular door being accessed. In some embodiments of the invention, different doors may have different maximum distances, while in other embodiments, all doors can have the same maximum distance. The present invention is flexible with decisions such as this depending on the particular facility or facility policies.

The application (App.) contained in the smart device will typically include various menus and possible commands for doors. It may simple be a general interface to open any door by supplying only a door identification and a desired action (open, close . . . ). On the other hand, it may be more complex and can be tailored for a particular facility. For example, particular doors may require higher security. In this case, a door access-code or password might be required. This can be a general pass code, or it can be door-specific. The App. can be designed to fit into more general enterprise security solutions such as the system known as KNOX supplied by Samsung to run on the Android Operating System. Also, the App. can require a biometric identification such as a fingerprint to operate.

As previously stated, while the present BLE technology beacon devices are preferred for distance determination, any distance determining method between a door and an electric device is within the scope of the present invention. Also, any communication technique between a door controller and a smart device or between a door controller, a smart device and a central computer or computers is within the scope of the present invention.

It is preferred that the BLE technology beacon device be in a separate module from the door controller; however, it is within the scope of the present invention to package it in the door controller itself or to associate it with the door controller in any other manner.

Several descriptions and illustrations have been presented to aid in understanding the present invention. A person with skill in the art will realize that numerous changes and variations may be made without departing from the spirit of the invention. Each of these changes and variations is within the scope of the present invention.

1. A system for controlling an industrial door from a smart device comprising:
a stand-alone device adapted to be located in proximity to an industrial door;
a first short-range communications device in electrical communication with the stand-alone device, the first short-range communications device adapted to broadcast a locating signal to other nearby short-range communications devices;
an application including first executable instructions configured to be executed by a processor in a smart device containing a second short-range communications device, the application providing a user with a selection of door control commands;
the application in the smart device configured to utilize the locating signal received by the second short-range communication device to determine a computed distance between the; smart device and the door by computing a distance between the first and second short range communications devices;
The application in the smart device also configured to accept a door control command request from a user and to forward the door control command request, and the computed distance between the smart device and the door, to a remote computer over a local-area network;
second executable instructions in the remote computer configured to verify the door control command request and to forward an operational door control command to a door controller associated with the door if the computed distance between the smart device and the door is less than or equal to a predetermined maximum distance.

2. The system for controlling an industrial door from a smart device of claim 1 wherein the smart device is also configured to send the operational door control command over the local area network to the door controller after determining that the distance between the smart device and the door is less than or equal to the predetermined maximum distance.

3-4. (canceled)

5. The system for controlling an industrial door from a smart device of claim 1 wherein the central computer is configured to verify the door command request by identifying the user, the door and the smartphone before sending the operational door control command to the door controller.

6. The system for controlling an industrial door from a smart device of claim 1 wherein the smart device communicates with the local-area network using WiFi.

7. The system for controlling an industrial door from a smart device of claim 2 wherein the smart device communicates with the local-area network using WiFi.

8. (canceled)

9. The system for controlling an industrial door from a smart device of claim 1 wherein the smart device is configured to send the door control command request and the computed distance between the smart device and the door, to the remote computer via a wide-area network.

10-18. (canceled)

19. The system for controlling an industrial door from a smart device of claim 1 wherein, the smart device is a smartphone or a tablet computer.

20. A system for controlling an industrial door from a smart device comprising:
a wireless beacon located in proximity to the door;
an application adapted to be executed on a smart device having short-range communication capability capable of reading a signal from the wireless beacon;
the application also adapted to determine a computed distance between the smart device and the door;
wherein, the application is configured to send a door command request for the door, along with the computed distance between the smart device and the door, over a network to a remote computer;
computer instructions executing on the remote computer adapted to receive the door command request and the distance between the smart device and the door, to verify the door command request, and to send a control command over the network to control the door if the door request is successfully verified and if the computed distance between the smart device and the door is less than or equal to a predetermined maximum distance.

21. The system for controlling an industrial door from a smart device of claim 20 wherein the network is a local-area network.

22. The system for controlling an industrial door from a smart device of claim 21 wherein the smart device communicates with the local-area network using WiFi.

23. The system for controlling an industrial door from a smart device of claim 20 wherein the beacon uses BLUETOOTH Low Energy (BLE).

24. The system for controlling an industrial door from a smart device of claim 20 wherein the door command request for the door, along with the distance between the smart device and the door, is encrypted before being sent over the network.

25. The system for controlling an industrial door from a smart device of claim 20 wherein, the smart device is a smartphone or a tablet computer

26. A method of providing a system for controlling an industrial door from a smart device comprising:
providing a wireless beacon located in proximity to an the door;
providing an application adapted to be executed on a smart device having short-range communication capability capable of reading a signal from the wireless beacon; the application also adapted to determine a computed distance between the smart device and the door; and
wherein, the application is configured to send a door command request for the door, along with the computed distance between the smart device and the door, over a network to a remote computer;
providing computer instructions executing on the remote computer adapted to receive the door command request, and the distance between the smart device and the door, verify the door command request, and send a control command over the network to control the door if the door request is successfully verified, and if the computed distance between the smart device and the door is less than or equal to a predetermined maximum distance.

27. The method of claim 26 wherein the network is a local-area network.

28. The method of claim 27 wherein the smart device communicates with the local-area network using WiFi.

29. The method of claim 26 wherein the beacon uses BLUETOOTH Low Energy (BLE).

30. The method of claim 26 wherein the door command request for the door, along with the computed distance between the smart device and the door, is encrypted before being sent over the network.

31. The method claim 26 wherein, the smart device is a smartphone or a tablet computer.

32. The method of claim 26 wherein the network is a wide-area network.
